(19) United States
(12) Patent Application Publication
(10) Pub. No.: US 2011/0210966 A1
(43) Pub. Date: Sep. 1, 2011

(54) APPARATUS AND METHOD FOR GENERATING THREE DIMENSIONAL CONTENT IN ELECTRONIC DEVICE

(75) Inventor: Sang-Kyung LEE, Anyang-si (KR)

(73) Assignee: Samsung Electronics Co., Ltd., Suwon-si (KR)

(21) Appl. No.: 12/950,624

(22) Filed: Nov. 19, 2010

(30) Foreign Application Priority Data
Nov. 19, 2009 (KR) 10-2009-0111890

(51) Int. Cl. G06T 15/00

(52) U.S. Cl. 345/419

(57) ABSTRACT

An apparatus and a method for generating Three Dimensional (3D) contents in an electronic device are provided. The method includes extracting data having geometric information, generating two images having binocular disparity using the geometric information of the extracted data, and outputting the generated two images to a display unit. The generating of the two images having the binocular disparity includes rendering a first image using the geometric information of the extracted data, and generating a second image using depth information of an object in the first image.

### PRIORITY

The present application claims priority under 35 U.S.C. §119(a) to a Korean Patent Application filed in the Korean Intellectual Property Office on Nov. 19, 2009 and assigned Serial No. 2009-0111890, the contents of which are incorporated herein by reference.

### BACKGROUND OF THE INVENTION

1. Field of the Invention

The present invention relates generally to an apparatus and a method for generating Three Dimensional (3D) contents in an electronic device, and more particularly, to an apparatus and a method for generating 3D contents using a projection matrix by considering binocular disparity in normalize coordinates.

2. Description of the Related Art

As virtual reality systems and computer games have seen a recent increase in development, there has likewise been an increase in research of techniques to represent objects and terrains of the World using a computer system in the three dimensions.

A user may experience the stereoscopic vision by observing a target object in different directions with a left eye and a right eye. When a two-dimensional flat display device displays two images reflecting the difference of the left eye and the right eye; that is, reflecting the binocular disparity at the same time, the user perceives the corresponding images in the three dimensions.

A conventional method obtains two images with the binocular disparity using a virtual camera. Vertex transformation of a general graphics pipeline converts object coordinates of the content to eye, clip, normalize and window coordinates as shown in FIG. 1. Using the virtual camera, the general graphics pipeline generates the binocular disparity 212 in a virtual space 210 by setting parameters 202 and 204 of the virtual camera and obtains two images with the binocular disparity reflected by rendering the image in the conventional pipeline as shown in FIG. 2.

However, such a conventional method has difficulty in applying the appropriate binocular disparity to 3D contents of various virtual space sizes because the parameters 202 and 204 of the virtual camera are fixed in the development phase. This problem results in two image outputs applying the excessive binocular disparity, which can cause eyestrain, worsening of eye vision, and headaches to the user.

To overcome those shortcomings, a method for dynamically resetting the camera parameters by analyzing the left and right displacement difference of the object is suggested. However, this method suffers from high complexity in determining the inverse of the matrix to reset the camera parameters, and does not guarantee mathematical accuracy. In addition, since it is necessary to modify the camera parameters after determining the left and right displacement difference of the object, and to determine again using the modified camera parameters, the determination is repeated. Further, It is also difficult to know the level of the binocular disparity in the image created in the display with the camera parameters (e.g., convergence angle and location) modified using the displacement, since the displacement size in the virtual space is the relative measure unit varying per content. In result, it is difficult for a developer to tune the camera parameters.

### SUMMARY OF THE INVENTION

To address the above-discussed deficiencies of the prior art, it is a primary aspect of the present invention to provide an apparatus and a method for generating 3D contents in an electronic device.

Another aspect of the present invention is to provide an apparatus and a method for generating 3D contents using a projection matrix considering binocular disparity in normalize coordinates in an electronic device.

Yet another aspect of the present invention is to provide an apparatus and a method for determining binocular disparity using a Z-axis distance of an object in normalize coordinates when 3D contents are generated in an electronic device.

Still another aspect of the present invention is to provide an apparatus and a method for acquiring two images reflecting binocular disparity by generating a projection matrix in consideration of the binocular disparity in normalize coordinates when 3D contents are generated in an electronic device.

According to the present invention, a method for generating stereoscopic contents in an electronic device includes extracting data having geometric information, generating two images having binocular disparity using the geometric information of the extracted data, and outputting the generated two images to a display unit. The generating of the two images having the binocular disparity includes rendering a first image using the geometric information of the extracted data, and generating a second image using depth information of an object in the first image.

According to the present invention, an apparatus for generating stereoscopic contents in an electronic device includes a controller for extracting data having geometric information, and generating two images having binocular disparity using the geometric information of the extracted data, and a display unit for outputting the generated two images. The controller renders a first image using the geometric information of the extracted data, and generates a second image using depth information of an object in the first image.

According to the present invention, a method for generating stereoscopic contents in an electronic device includes applying a first projection matrix to eye coordinate data constituted based on geometric information data, clipping an object falling outside a visual area by applying the first projection matrix, generating a first image by converting data contained in the visual area to normalize coordinate data, determining a second projection matrix by measuring depth information of an object in the normalize coordinates for the first image, clipping an object falling outside a visual area by applying the second projection matrix to the eye coordinate data, and generating a second image by converting data contained in the visual area to normalize coordinate data.

### BRIEF DESCRIPTION OF THE DRAWINGS

For a more complete understanding of the present invention and its advantages, reference is now made to the following description taken in conjunction with the accompanying drawings, in which:

FIG. 1 illustrates vertex transformation of a conventional graphics pipeline;

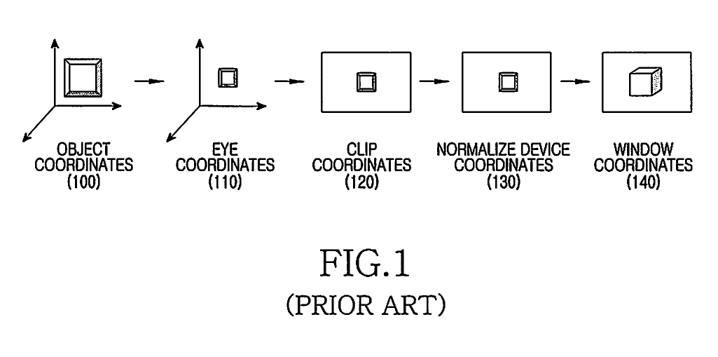

FIG. 2 illustrates conventional vertex transformation for obtaining two images with binocular disparity using camera parameters;

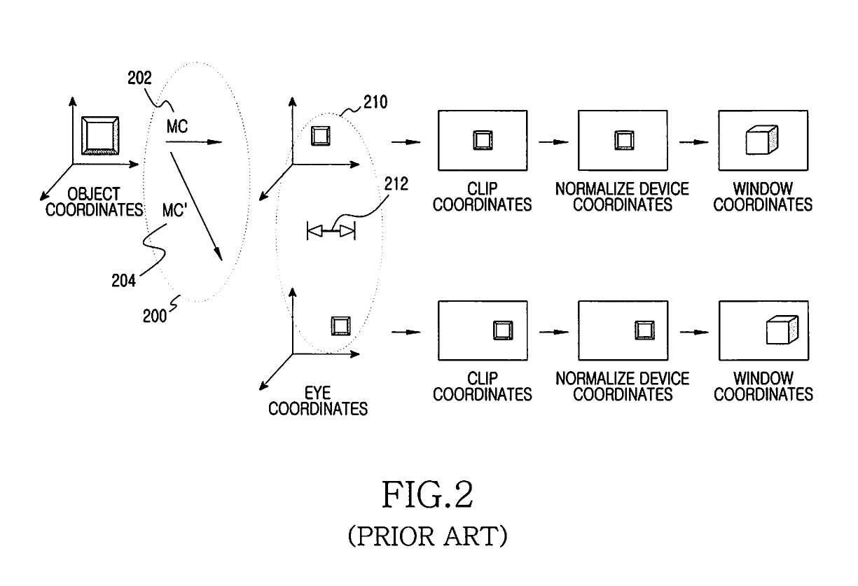

FIG. 3 illustrates vertex transformation for obtaining two images with binocular disparity using a projection matrix in consideration of the binocular disparity in an electronic device according to an embodiment of the present invention;

FIG. 4 illustrates an apparatus for generating 3D contents in the electronic device according to an embodiment of the present invention;

FIG. 5 illustrates a projection matrix determiner and applier in the electronic device according to an embodiment of the present invention;

FIG. 6 illustrates parallax and a pixel difference value reflected on a rendered screen in the electronic device according to an embodiment of the present invention;

FIG. 7 illustrates operations of the electronic device according to an embodiment of the present invention;

FIG. 8 illustrates the electronic device according to an embodiment of the present invention; and

FIG. 9 illustrates a display system of a display unit according to an embodiment of the present invention.

Throughout the drawings, like reference numerals will be understood to refer to like parts, components and structures.

### DETAILED DESCRIPTION OF EMBODIMENTS OF THE INVENTION

Embodiments of the present invention are described in detail herein with reference to the accompanying drawings. In the drawings, the same or similar components may be designated by the same or similar reference numerals, although they are illustrated in different drawings. Further, detailed descriptions of constructions or processes known in the art may be omitted for the sake of clarity and conciseness, and to avoid obscuring the subject matter of the present invention.

The terms and words used in the following description and claims are not limited to the bibliographical meanings, but are merely used by the inventor to enable a clear and consistent understanding of the invention. Accordingly, it should be apparent to those skilled in the art that the following description is provided for illustration purposes only and not for limiting the invention as defined by the appended claims and their equivalents.

Embodiments of the present invention provide a method and an apparatus for generating 3D contents using a projection matrix in consideration of binocular disparity of normalize coordinates in an electronic device. The electronic device herein includes a display, such as digital TVs, portable terminals, mobile communication terminals, and Personal Computers (PCs). The 3D contents, which are an application file executed by a virtual machine or a player installed to the electronic device, indicate contents that independently operate without association with other applications or contents, build a 3D virtual world and execute a rendering process. In particular, the 3D contents indicate stereoscopic contents rendered based on a computer graphics technology and output as two images with the binocular disparity reflected. Hereinafter, the two images with the binocular disparity are referred to as a left image and a right image, respectively.

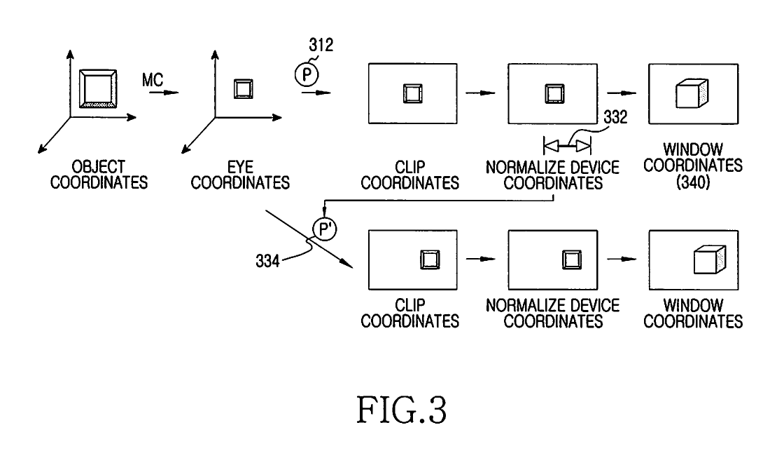

FIG. 3 illustrates vertex transformation for obtaining two images with binocular disparity using a projection matrix in consideration of the binocular disparity in an electronic device according to an embodiment of the present invention. The vertex transformation constitutes object coordinates for the content, and converts to eye coordinates, clip coordinates, normalize device coordinates, and window coordinates as shown in FIG. 3.

As a left image of the object is generated through the pipeline, binocular disparity 332 according to a Z-axis distance of the object is determined, a projection matrix P′ 334 based on the binocular disparity 332 is generated, and thus a right image of the object is generated and rendered as shown in FIG. 3. That is, as the projection coordinates are converted to the normalize device coordinates for the left image, the binocular disparity 332 of the pixel unit is determined according to the Z-axis distance of the object, the projection matrix P′ 334 based on the binocular disparity 332 is generated based on the following Equation (1), and the right image is generated using the projection matrix P′ 334.

$${V}_{o} M C P = {V}_{p} \\ {V}_{p} \frac{1}{w} = {V}_{pn} \\ {V}_{pn} \cdot x + \frac{d}{WIDTH} = {V}_{pn}^{′} \\ {V}_{o} M C {P}^{′} = {V}_{p}^{′} \qquad ( 1 )$$

In Equation (1), Vₒ denotes a vertex in local coordinates, MC denotes a model view transformation matrix, P denotes the projection matrix, and Vₚ denotes a vertex of project coordinates. Vₚₘ denotes a vertex transformed from Vₚ into the normalize device coordinates (or the normalize coordinates), w denotes a w component of homogeneous coordinates represented in four dimensions, WIDTH denotes a distance value from the display center to a horizon maximum pixel, and d denotes a pixel value indicating the difference when an image is formed in the display according to the binocular disparity. Vₚₙ′ denotes the vertex shifted by the binocular disparity in the normalize device coordinates, and Vₚ′ denotes the vertex transformed from Vₚₙ′ back into the projection coordinates.

To render the right image having the binocular disparity from the left image, it is necessary to determine P′ converting Vₒ to Vₚ′ based on Equation (1).

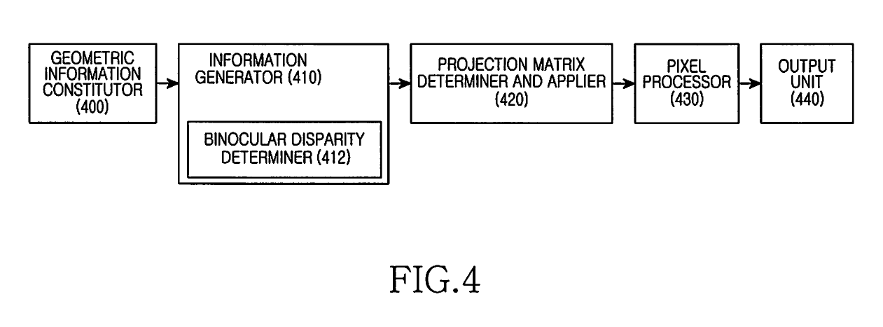

FIG. 4 illustrates an apparatus for generating the 3D contents in the electronic device according to an embodiment of the present invention.

The apparatus of FIG. 4 includes a geometric information constitutor 400, an information generator 410, a projection matrix determiner and applier 420, a pixel processor 430, and an output unit 440. The information generator 410 includes a binocular disparity determiner 412.

The geometric information constitutor 400 constitutes geometric information of the object to render from the input content and provides the geometric information to the information generator 410. The geometric information indicates graphics data including x-axis, y-axis, and z-axis information for the vertex.

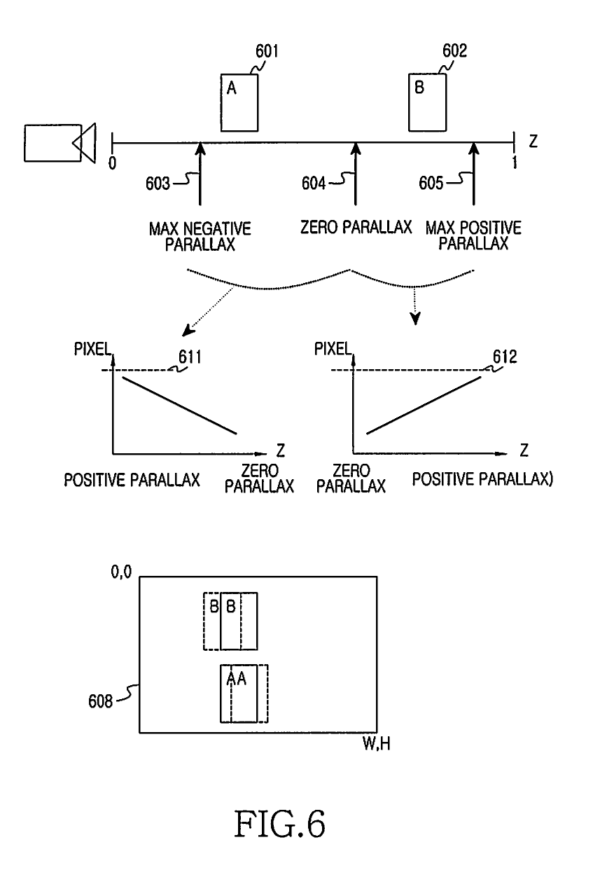

The information generator 410 generates a binocular parallax reference point, sets a reference point value per object or per rendering scene, and provides the reference point to the projection matrix determiner and applier 420. The information generator 410 including the binocular disparity determiner 412 determines the binocular disparity according to the Z-axis distance of the object in the normalize device coordinates and provides the binocular disparity to the projection matrix determiner and applier 420. The binocular parallax reference point includes a zero parallax 604, a max negative parallax 603, and a max positive parallax 605 as shown in FIG. 6. The max negative parallax 603 and the max positive parallax 605 are the start points of the greatest left and right pixel difference based on the zero parallax 604 in a negative parallax region and a positive parallax region, and imply a maximum pixel value of the binocular disparity in the positive or negative direction. When the left and right pixel difference value is mapped to the max negative parallax 603, this implies that the right image is rendered at the location horizontally shifted by the left and right pixel differences 611 and 612 in the rendered left and right images of the object when an object is placed and viewed at the point of the max negative parallax 603 in the display screen.

The binocular disparity determiner 412 maps the left and right pixel differences reflected according to the Z-axis distance of the object, to a function, and determines the binocular disparity using the function. In so doing, the binocular disparity determiner 412 may define the function such that the pixel value decreases as the Z-axis distance for the zero parallax is shortened, and the pixel value increases as the Z-axis distance extends in the negative or positive direction as shown in FIG. 6. Note that the function may vary according to display characteristics or stereoscopic effect.

For example, when an object A 601 is located in the negative parallax region and an object B 602 is located in the positive parallax region of the virtual space as shown in FIG. 6, the binocular disparity of the object A 601 and the object B 602 in the display screen 608 is determined according to the set parallax reference point, the Z-axis distance of the object, and the mapped left and right image pixel difference value. The display screen 608 may display the solid-line objects A and B as the left image and the dotted-line objects A and B as the right image. The reference point indicating the zero parallax 604, the max negative parallax 603, and the max positive parallax 605 may be set automatically by extracting from the corresponding objects per scene, fixed in the system, and set and changed by a user's manipulation. An object outside the max negative parallax 603 or the max positive parallax 605 may adopt the left and right image pixel difference values 611 and 612 mapped with the max negative parallax or the max positive parallax, which prevents excessive binocular disparity.

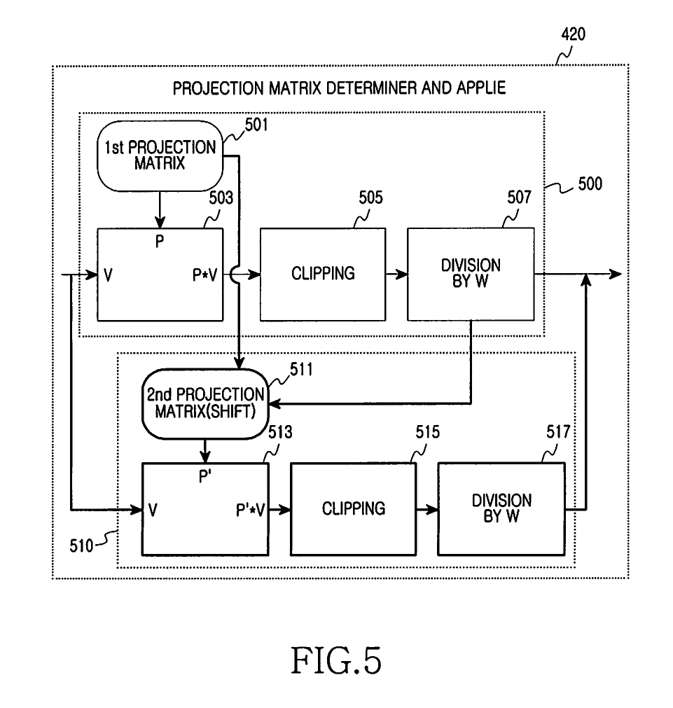

The projection matrix determiner and applier 420 receives information required to render the object and the binocular disparity from the information generator 410, generates the projection matrix considering the binocular disparity based on Equation 1, and uses the projection matrix to render the right image. The projection matrix determiner and applier 420 includes a part 500 for determining a first projection matrix P and generating the left image of the object, and a part 510 for determining a second projection matrix by reflecting the binocular disparity determined by the binocular disparity determiner 412 and generating the right image using the second projection matrix P′ as shown in FIG. 5.

More specifically, the projection matrix determiner and applier 420 of FIG. 5 receives the eye coordinate data of the object, transforms 503 the input eye coordinate data V to a unit cube by applying the predetermined projection matrix P 501, clips 505 the object falling outside the visual area in the converted data, divides the data in the visual area by the wcomponent of the homogeneous coordinates to transform 507 to the normalize device coordinates, and thus generates the left image of the object. When the binocular disparity determiner 412 determines the binocular disparity according to the Z-axis distance indicating the depth of the object in the normalize device coordinates of the left image, the projection matrix determiner and applier 420 may generate the projection matrix P′ 511 reflecting the binocular disparity, transform the input eye coordinate data V to the unit cube 513 by applying the generated projection matrix P′, clip 515 the transformed data, and convert to the normalize device coordinates 517 by dividing the clipped data by the w component of the homogeneous coordinates, and thus generate the right image of the object.

The pixel processor 430 determines the screen output value for the pixels forming the left image and the right image rendered through the binocular disparity determiner 412 and the projection matrix determiner and applier 420. That is, the pixel processor 430 processes color, shading, and texture mapping for the polygon formed with the vertexes of the left image and the right image.

The output unit 410 displays the left image and the right image rendered by applying the binocular disparity, in the screen.

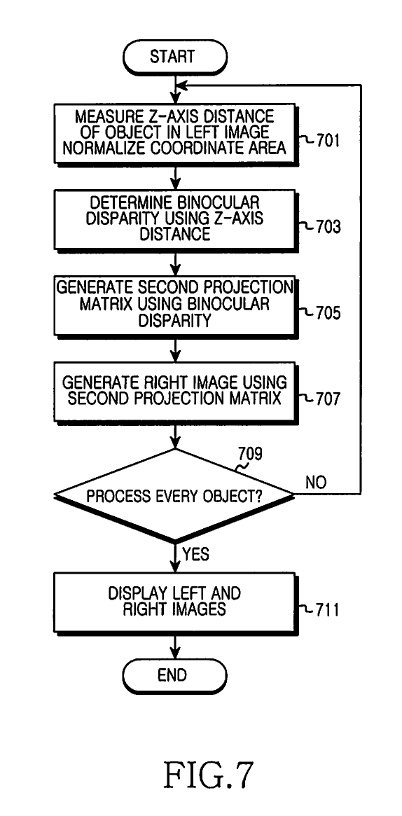

FIG. 7 illustrates operations of the electronic device according to an embodiment of the present invention.

In step 701, the electronic device measures the Z-axis distance of the object in the normalize device coordinates of the left image in the pipeline process for generating the left image of the object. The electronic device determines the binocular disparity using the Z-axis distance in step 703 and generates the second projection matrix for generating the right image using the binocular disparity in step 705. To determine the binocular disparity, the electronic device may use the function indicating the left and right pixel difference based on the Z-axis distance of the object by considering the zero parallax, the max negative parallax, and the max positive parallax as shown in FIG. 6. The electronic device may generate the second projection matrix by considering the binocular disparity based on Equation (1).

The electronic device generates the right image using the second projection matrix in step 707, and determines whether every object is processed in step 709. When every object is not processed, the electronic device returns to step 701. When every object is processed, the electronic device renders and displays the left and right images in the screen in step 711, and then finishes this process.

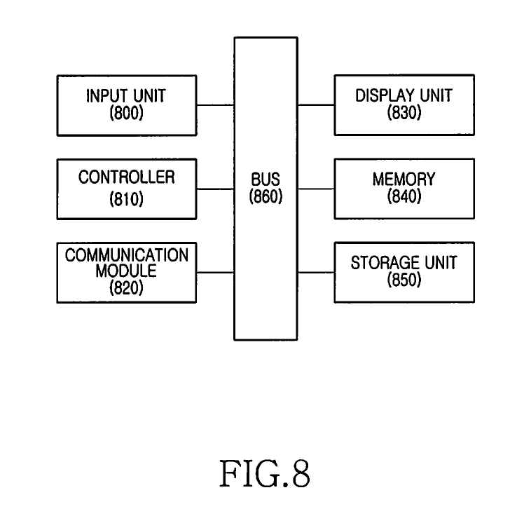

FIG. 8 illustrates the electronic device according to an embodiment of the present invention.

The electronic device of FIG. 8 includes an input unit 800, a controller 810, a communication module 820, a display unit 830, a memory 840, and a storage unit 850.

The input unit 800 includes at least one key or touch sensor. The input unit 800 detects the location of the key or the touch input by the user on the screen and provides the corresponding data to the controller 810. In particular, the input unit 800 detects and provides the input requesting to play the 3D contents to the controller 810. The input unit 800 receives the binocular parallax reference points, that is, the zero parallax, the max negative parallax, and the max positive parallax from the user, and provides them to the controller 810.

The controller 810 controls and processes operations of the electronic device. In particular, when the 3D content play is requested through the input unit 800, the controller 810 renders the 3D contents selected by the user and provides the rendered 3D contents to the display unit 830 via the memory 840. That is, when the 3D content play is requested through the input unit 800, the controller 810 receives the 3D contents from the storage unit 850 or the communication module 820 according to the user's control, generates left images and right images of the binocular disparity from the 3D contents, and outputs the generated images to the memory 840.

In further detail, the controller 810 performs the graphics pipeline process that renders the 3D contents by constituting the geometric information. While generating the left image, the controller 810 determines the binocular disparity according to the Z-axis distance of the corresponding object.

Next, the controller 810 generates the projection matrix of the right image reflecting the binocular disparity, creates the right image for the corresponding object, and renders the generated left image and right image. The controller 810 may determine the binocular disparity using the binocular parallax reference points input through the input unit 800, or using the binocular parallax reference points stored to the storage unit 850. The controller 800 may include the geometric information constitutor 400, the information generator 410, the projection matrix determiner and applier 420, and the pixel processor 430 of FIG. 4, and generate the left image and the right image of the binocular disparity.

The communication module 820 processes signals sent to and received from an external device under the control of the controller 810. The communication module 820 receives the 3D contents from the external device and forwards the 3D contents to the controller 810.

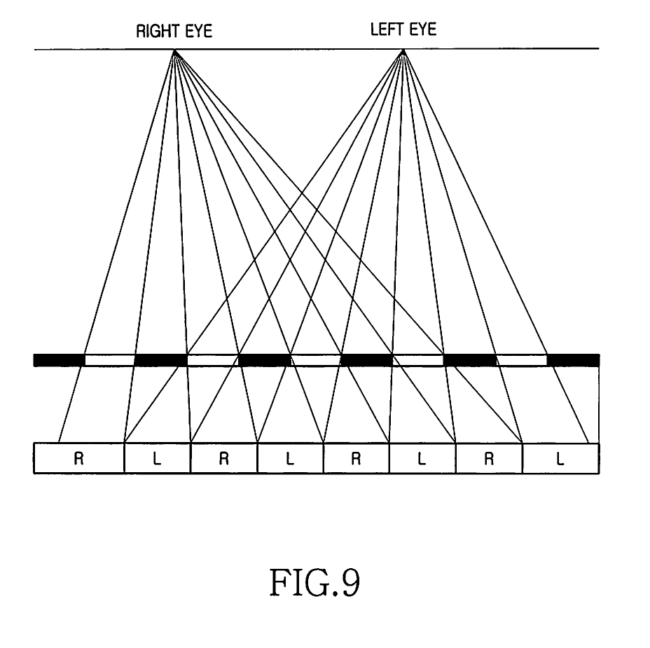

The display unit 830 displays state information, numbers, characters, and images generating in the operations of the electronic device. The display unit 830 may be implemented using a liquid crystal display. Particularly, the display unit 830, which includes a device capable of displaying stereoscopic images, may display the left image and the right image of the binocular disparity in the three dimensions. In so doing, the device displaying the stereoscopic image may drive only when the 3D contents are played and displayed under the control of the controller 810. Herein, the stereoscopic image display device includes every device capable of concurrently outputting the left image and the right image so that the user may perceive the depth of the vision by uniting the left image with the right image. For example, the display unit 830 may include barrier-type displays for creating the sense of depth by alternately displaying the left image and the right image over a parallax barrier as shown in FIG. 9.

The memory 840, which is a working memory of the controller 810, stores temporary data generating in program executions. More specifically, the memory 840 temporarily stores the left image and the right image fed from the controller 810, and outputs the temporarily stored left image and right image to the display unit 830 under the control of the controller 810. Herein, the memory 840 may be a Random Access Memory (RAM).

The storage unit 850 stores programs and data for operating the electronic device. In this embodiment, the storage unit 850 stores the 3D contents, which indicate the stereoscopic contents rendered based on the computer graphics technology and produced as two images with the binocular disparity reflected. The storage unit 850 stores the binocular parallax reference points, that is, the zero parallax, the max negative parallax, and the max positive parallax. The binocular parallax reference points may be preset according to the characteristics of the display unit 830. The storage unit 850 may be a Read Only Memory (ROM) or a flash ROM.

A bus 860 is an electrical channel shared by the components of the electronic device to send and receive information.

So far, the left image of the object is generated, the binocular disparity is determined in the normalize device coordinates of the left image, the projection matrix is determined by reflecting the binocular disparity, and thus the right image is created. Note that the images may be created in the converse. That is, the right image of the object may be generated, the binocular disparity may be determined in the normalize device coordinates of the right image, the projection matrix may be determined by reflecting the binocular disparity, and thus the left image may be created.

As set forth above, when the 3D contents are generated in the electronic device, the binocular disparity is determined using the Z-axis distance of the object in the normalize coordinates, and the two images reflecting the binocular disparity are produced by generating the projection matrix based on the binocular disparity. Accordingly, eyestrain is alleviated by prevention of excessive binocular disparity, the computational load of the system is reduced with the lower computational complexity than in the conventional methods, and the stereoscopic vision is flexibly adjusted according to the hardware characteristics and the rendering effect by varying the binocular disparity per region or per model. Further, even contents created without considering the stereoscopic display are automatically converted to the stereoscopic contents.

Although the present invention has been described with the foregoing embodiment, various changes and modifications may be suggested to one skilled in the art. It is intended that the present disclosure encompass such changes and modifications as fall within the scope of the appended claims.

1-10. (canceled)

11. A method for generating stereoscopic contents in art electronic device, comprising:
extracting data having geometric information;
generating two images having binocular disparity using the geometric information of the extracted data, by rendering a first image using the geometric information of the extracted data, and generating a second image using depth information of an object in the first image; and
outputting the generated two images to a display unit.

12. The method of claim 11, wherein the depth information of the object is obtained by measuring a Z-axis distance of the object through normalize device coordinates when the first image is rendered.

13. The method of claim 11, wherein the generating of the second image using the depth information comprises:
determining the binocular disparity using the depth information;
determining a projection matrix of the second image using the binocular disparity; and
generating the second image using the determined projection matrix.

14. The method of claim 11, wherein the binocular disparity is determined using a binocular parallax reference point including at least one of a zero parallax, a max negative parallax, and a max positive parallax.

15. The method of claim 14, wherein the binocular parallax reference point is one of a value pre-stored to a storage unit, a value set based on the depth information of objects, and a value set by a user through an input unit.

16. The method of claim 11, wherein the display unit comprises a stereoscopic image output device that concurrently outputs a left image and a right image.

17. The method of claim 16, further comprising:
driving the stereoscopic image output device when a user generates a stereoscopic play event.

18. The method of claim 11, wherein the data having geometric information is extracted from contents provided through one of the storage unit and an external device, and the contents are created based on graphics technology.

19. An apparatus for generating stereoscopic contents in an electronic device, comprising:
a controller for extracting data having geometric information, and generating two images having binocular disparity using the geometric information of the extracted data; and
a display unit for outputting the generated two images,
wherein the controller renders a first image using the geometric information of the extracted data, and generates a second image using depth information of an object in the first image.

20. The apparatus of claim 19, wherein the controller obtains the depth information by measuring a Z-axis distance of the object through normalize device coordinates when the first image is rendered.

21. The apparatus of claim 19, wherein the controller determines the binocular disparity using the depth information, determines a projection matrix of the second image using the binocular disparity, and generates the second image using the determined projection matrix.

22. The apparatus of claim 20, wherein the controller determines the binocular disparity using a binocular parallax reference point which includes at least one of a zero parallax, a max negative parallax, and a max positive parallax.

23. The apparatus of claim 22, wherein the controller determines the binocular disparity using one of a binocular parallax reference value pre-stored to the storage unit, a binocular parallax reference value set based on the depth information of objects, and a binocular parallax reference value set by a user through an input unit.

24. The apparatus of claim 23, wherein the display unit comprises a stereoscopic image output device that concurrently outputs a left image and a right image.

25. The apparatus of claim 24, wherein the controller drives the stereoscopic image output device when a user generates a stereoscopic play event.

26. The apparatus of claim 19, wherein the controller extracts the data having geometric information from contents provided through one of the storage unit and an external device, and the contents are created based on graphics technology.

27. A method for generating stereoscopic contents in an electronic device, comprising:
applying a first projection matrix to eye coordinate data constituted based on geometric information data;
clipping an object that is outside of a visual area by applying the first projection matrix;
generating a first image by converting data included in the visual area to normalize coordinate data;
determining a second projection matrix by measuring depth information of an object in the normalize coordinates for the first image;
clipping an object that is outside of a visual area by applying the second projection matrix to the eye coordinate data; and
generating a second image by converting data included in the visual area to normalize coordinate data.

28. The method of claim 27, wherein the determining of the second projection matrix by measuring the depth information of the object comprises:
determining binocular disparity using the depth information; and
determining a projection matrix of the second image using the binocular disparity.

29. The method of claim 27, wherein the binocular disparity is determined using a binocular parallax reference point which includes at least one of a zero parallax, a max negative parallax, and a max positive parallax.

30. The method of claim 29, wherein the binocular parallax reference point is one of a pre-stored value, a value set based on the depth information of objects, and a value set by a user.
